(19) United States
(12) Patent Application Publication
(10) Pub. No.: US 2025/0240322 A1
(43) Pub. Date: Jul. 24, 2025

(54) DETECTING IMPERSONATION ATTACKS

(71) Applicant: Kyndryl, Inc., New York, NY (US)

(72) Inventors: Cesar Augusto Rodriguez Bravo, Alajuela (CR); David Alonso Campos Batista, Aurora (CR); Daniel S. Riley, Wake Forest, NC (US); KIM POH WONG, Singapore (SG)

(21) Appl. No.: 18/421,531

(22) Filed: Jan. 24, 2024

(51) Int. Cl. H04L 9/40

(52) U.S. Cl. CPC H04L 63/1483

(57) ABSTRACT

Embodiments determine a set of writing patterns of at least one data communication; determine a narrative style on the set of writing patterns of the at least one data communication; provide a writing profile model by training on the narrative style and the set of writing patterns; compare a new data communication to the trained writing profile model; and flag the new data communication based on the comparison being over a threshold level.

### BACKGROUND

Aspects of the present invention relate generally to detection of impersonation attacks and, more particularly, to a system and method of detecting the impersonation attacks by identifying a writing pattern of a sender.

An impersonation attack is a type of targeted phishing attack in which a person pretends to be someone else or another entity to steal sensitive data from an unsuspecting person using social engineering tactics. In particular, the person attempts may be used to trick the unsuspecting person into transferring money or divulging sensitive information.

### SUMMARY

In a first aspect of the invention, there is a computer-implemented method including: determining, by the computing device, a set of writing patterns of at least one data communication; determining, by the computing device, a narrative style on the set of writing patterns of the at least one data communication; providing, by the computing device, a writing profile model by training on the narrative style and the set of writing patterns; comparing, by the computing device, a new data communication to the trained writing profile model; and flagging, by the computing device, the new data communication based on the comparison being over a threshold level.

In another aspect of the invention, there is a computer program product including one or more computer readable storage media having program instructions collectively stored on the one or more computer readable storage media. The program instructions are executable to: determine a set of writing patterns of at least one data communication; determine a narrative style based on the set of writing patterns of the at least one data communication; provide a writing profile model by training on the narrative style and the set of writing patterns; compare a new data communication to the trained writing profile mode; and flag the new data communication based on the comparison being over a threshold level.

In another aspect of the invention, there is system including a processor, a computer readable memory, one or more computer readable storage media, and program instructions collectively stored on the one or more computer readable storage media. The program instructions are executable to: receive at least one incoming email from a user device; determine at least one writing pattern based on the at least one incoming email; cluster the at least one writing pattern using at least one algorithm; rank the clustered at least one writing pattern; rate the ranked at least one writing pattern; determine a narrative style based on the rated at least one writing pattern; provide a writing profile model by training on the narrative style and the rated at least one writing pattern; compare a new email to the trained writhing profile model; and flag the new email based on the comparison being over a threshold level.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an attack detection system in accordance with aspects of the present invention.

FIG. 5 shows a flowchart of the attack detection system in accordance with aspects of the present invention.

FIG. 6 shows writing pattern examples using the writing pattern detection in accordance with aspects of the present invention.

FIG. 7 shows an example of ranking and rating in accordance with aspects of the present invention.

FIG. 8 shows narrative style examples in accordance with aspects of the present invention.

FIG. 9 shows an example of flag detection in accordance with aspects of the present invention.

### DETAILED DESCRIPTION

Aspects of the present invention relate generally to detection of impersonation attacks. In more specific embodiments, aspects of the present invention relate to systems and methods of detecting the impersonation attacks by identifying a writing pattern of a sender. According to aspects of the invention, the system is directed to creating a layer of defense to identify and prevent impersonation attacks at a corporate or business level by analyzing a writing profile of an email or other type of phishing attempt against a stored writing profile of one or more senders. Further, although the system is directed to analyzing writing profiles of an email, embodiments are not limited to this example. For example, the embodiments of the present invention are also directed to analyzing any type of digital communication, such as instant messaging, corporate messaging (e.g., Slack®, Teams®), etc.

Embodiments of the present invention implement natural language processing (NLP) to determine writing patterns of a user (e.g., sender). Further, embodiments of the present invention uses an ensemble of clustering algorithms to rate writing patterns of an identified user. Moreover, embodiments of the present invention create a narrative style profile based on an analysis of digital communications. The narrative style profile can be used to compare against incoming emails to determine if there is an impersonation attack.

In more specific embodiments, the system creates a writing profile that is based on a plurality of items, including the narrative style and writing patterns. The system contrasts incoming emails (or other electronic exchanges) against a writing profile to determine a risk of impersonation attacks. Also, in implementing embodiments of the present invention, warnings can be provided to users about impersonation attacks, such as email scams, email spam, whaling attacks, impersonation attacks, false logins, brute force attacks, stolen credentials, abuse of credentials, etc. In this way, it is now possible to enhance the security of different applications and systems, such as a platform as a service (PaaS) systems, a software as a service (SaaS) systems (e.g., web applications), intrusion prevention system (IPS), intrusion detection system (IDS), and collaboration systems (e.g., Sharepoint®). This may be used to provide threat intelligence at a corporate or business level.

According to an aspect of the invention, a computer-implemented method includes: obtaining a set of writing samples from a user; determining, based on the set of writing samples, a set of writing patterns for the user; applying a plurality of clustering algorithms to the set of writing patterns; determining, based on the plurality of clustering algorithms and the set of writing patterns, a narrative style for the user; obtaining a communication, the communication asserting to originate from the user; determining, based on the narrative style for the user and the communication, the communication fails to meet a confidence threshold; and informing at least a receiver of the communication of the failure. The computer-implemented method also includes the set of writing patterns having a combination of one or more of misspellings, bilingual idiosyncrasies, image use, writing style, punctuation, and formatting. The computer-implemented method also includes the confidence threshold having a measure of similarities of a writing pattern analysis and a narrative style analysis of the communication to the writing patterns and narrative style for the user.

Accordingly, implementations of the present invention provide an improvement in the technical field of preventing impersonation attacks by detecting writing patterns of a sender. The prevention of impersonation attacks can be provided at a corporate or business level by analyzing a writing profile of a communication (e.g., email) and comparing the writing profile of the communication to a stored writing profile of the sender of the communication. In contrast, known systems use gender identification, authorship verification, geolocation, email filters, or authentication of public key certificate data to prevent attacks.

Implementations of the present invention are necessarily rooted in computer technology. For example, the step of training a writing profile model to improve the accuracy of flagging digital communication is computer-based and cannot be performed in the human mind. Training and building the writing profile model is, by definition, performed by a computer and cannot practically be performed in the human mind (or with pen and paper) due to the complexity and massive amounts of calculations involved. For example, training and building the writing profile model in embodiments of the present invention may use machine learning (ML) to build and train the writing profile model using feedback data to improve accuracy of flagging the digital communication. In particular, training and building the writing profile model performs a large amount of processing the feedback data and modeling of parameters to train the writing profile model such that the writing profile model generates and outputs in real time (or near real time). In other words, the writing profile model is trained using a large amount of previously captured digital communications (e.g., email) and other parameters such that the writing profile model is configured to output flagged digital communications in real-time. Given the scale and complexity of processing captured digital communications and feedback data and modeling of parameters, it is simply not possible for the human mind, or for a person using pen and paper, to perform the number of calculations involved in training and/or building the writing profile model.

It should be understood that, to the extent implementations of the invention collect, store, or employ personal information provided by, or obtained from, individuals (for example, users of digital communication applications), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

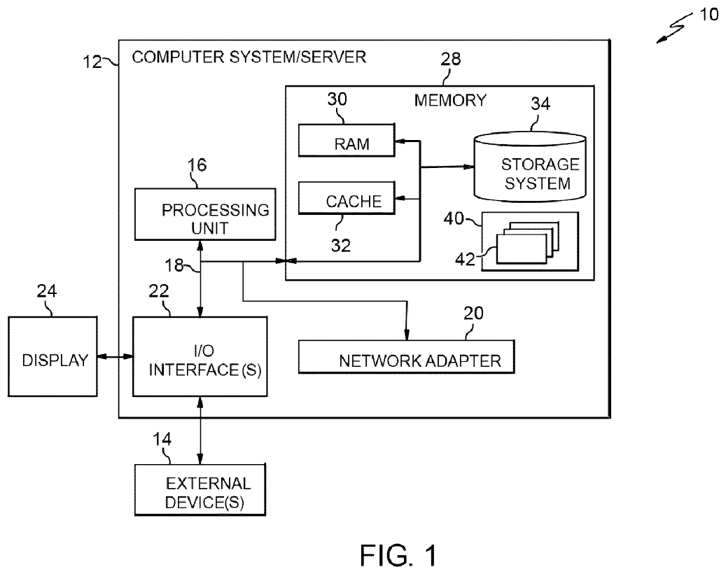

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

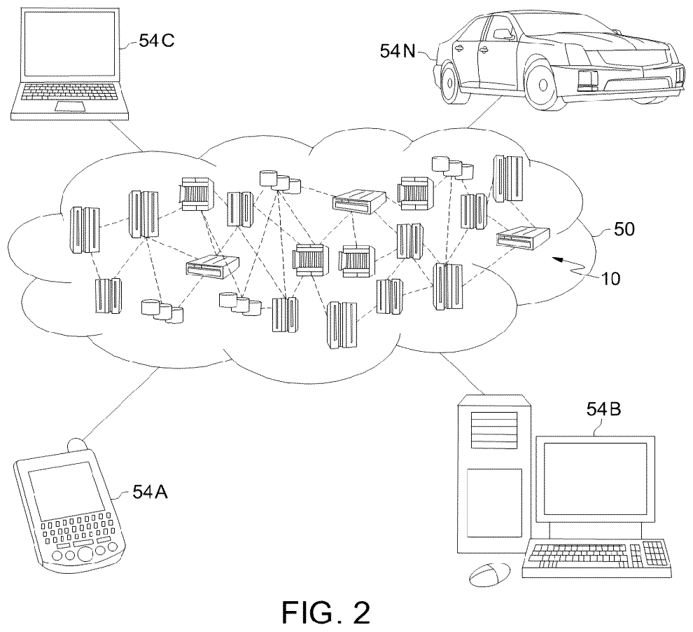

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

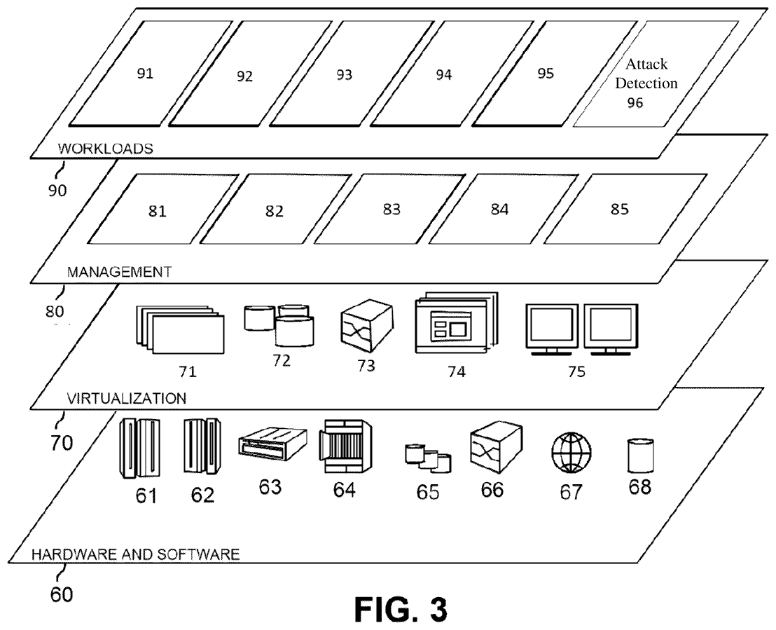

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and attack detection 96.

Implementations of the invention may include a computer system/server 12 of FIG. 1 in which one or more of the program modules 42 are configured to perform (or cause the computer system/server 12 to perform) one of more functions of the attack detection 96 of FIG. 3. For example, the one or more of the program modules 42 may be configured to: receive at least one incoming data communication from a user device; determine a writing pattern based on at least one incoming data communication; cluster the writing pattern using at least one algorithm; rank the clustered writing pattern; rate the ranked writing pattern; determine a narrative style based on the rated writing pattern; train a writing profile model based on the rated writing pattern; and flag the at least one incoming data communication based on a plurality of writing profiles in a writing profile database and the trained writing profile model.

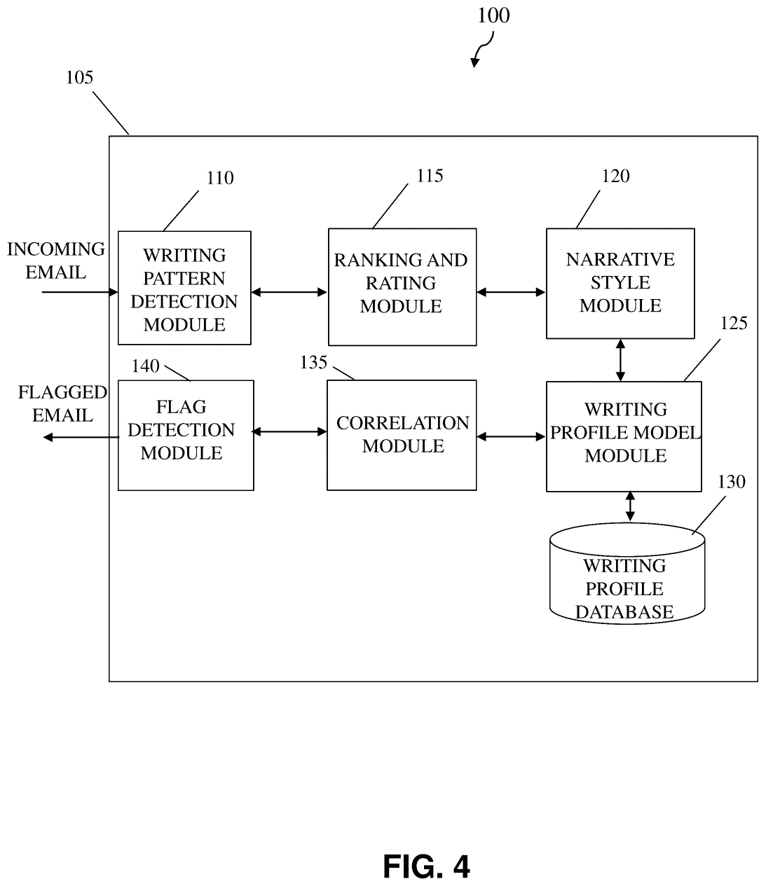

FIG. 4 shows a block diagram of an attack detection system in accordance with aspects of the invention. In embodiments, the attack detection system 100 comprises an attack detection environment 105 which includes a writing pattern detection module 110, a ranking and rating module 115, a narrative style model 120, a writing profile model module 125, a writing profile database 130, a correlation module 135, and a flag detection module 140, each of which may comprise one or more program modules such as program modules 42 described with respect to FIG. 1 and the attack detection 96 of FIG. 3.

The attack detection system 100 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

In embodiments of FIG. 4, the writing pattern detection module 110 receives an incoming email from a device of a sender. In embodiments, the writing pattern detection module 110 determines a writing pattern of the incoming email by using natural language processing (NLP). In particular, the writing pattern detection module 110 scans the incoming email and determines the writing pattern of the incoming email using NLP techniques by detecting spelling mistakes, different and mixed languages, e.g., bilingual idiosyncrasies, images (e.g., type of bullets, position preferences of the images, etc.), a writing style (e.g., indentation, comma usage, spaces between sentences/paragraphs, etc.), grammar, and a format (e.g., bold, italics, colors, use of tildes, use of titles, etc.) In embodiments, the scanning implemented in the writing pattern detection module 110 may include scans of the body of the email, the subject of the email, the sending email addresses, the destination email addresses, and the attachments of the email. For example, the writing pattern detection module 110 determines a first writing pattern of a first sender which includes use of rich text, an analytical narrative style, and perfect grammar. In another example, the writing pattern detection module 110 determines a second writing pattern of a second sender which includes no use of rich text, a definition narrative style, and inaccurate grammar. It should be understood by those of skill in the art that other patterns can be detected for emails or other communications of different senders. In embodiments, the first sender may be different from the second sender. The writing pattern detection module 110 then sends the writing pattern of the incoming email to the ranking and rating module 115.

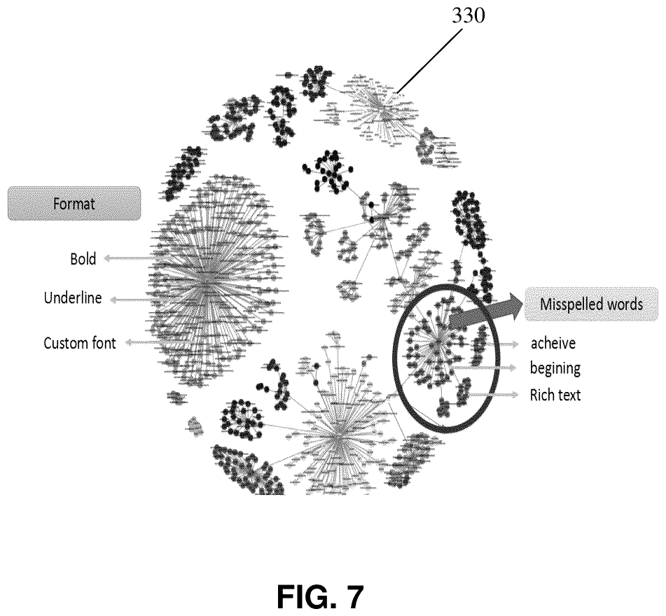

In embodiments of FIG. 4, the ranking and rating module 115 receives the writing pattern of the incoming email and clusters, ranks, and rates the writing pattern of the incoming email using a plurality of algorithms. In embodiments, the rank and rating module 115 uses a balanced iterative reducing and clustering using hierarchies (BIRCH) algorithm and an affinity propagation clustering algorithm. In embodiments, for example, the BIRCH algorithm builds a clustering feature (CF) tree to create a summary based on the received writing pattern and then uses hierarchical clustering to cluster the summary (as representatively shown in FIG. 7). In other embodiments, the affinity propagation clustering algorithm uses a similarity matrix, an availability matrix, a responsibility matrix, and/or a criterion matrix to cluster the received writing patterns into representative clustered sets.

After the rank and rating module 115 clusters using the BIRCH and affinity propagation clustering algorithms, as examples, the rank and rating module 115 ranks the clustered writing patterns based on a number of occurrences of different features in the writing. For example, the rank and rating module 115 ranks the clustered writing patterns based on a number of bold occurrences, a number of underline occurrences, a number of custom font occurrences, a number of misspelled words (e.g., achieve, beginning, etc.), or a number of rich text occurrences. Then, the rank and rating module 115 numerically rates the ranked writing patterns. The ranking and rating module 115 sends the rated writing patterns to the narrative style module 120.

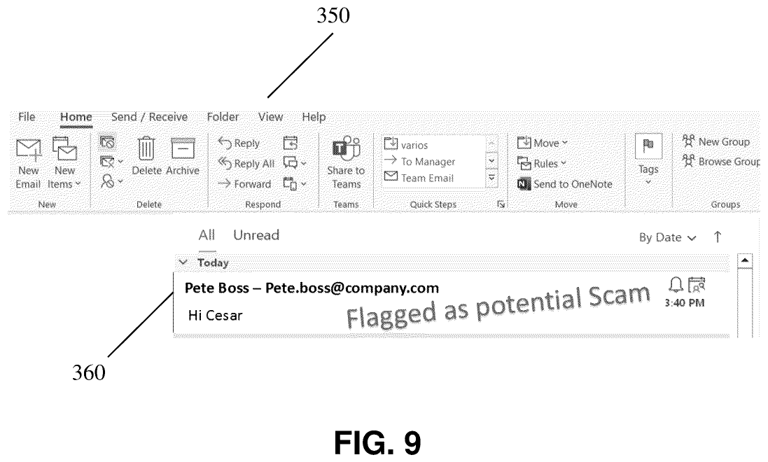

In embodiments of FIG. 4, the narrative style module 120 receives the rated writing patterns and determines a narrative writing style of the rated writing patterns. For example, the narrative writing style can be one of a narrative style, an informative style, an analytical style, an augmentative style, an expository style, a reflective style, a descriptive style, a synthesis style, a definition style, a persuasive style, a cause and effective style, a personal narrative, and a compare and contrast style (as shown in FIG. 9). However, embodiments of the present invention are not limited to these narrative styles and may include other narrative styles.

In embodiments, the narrative style module 120 determines the narrative writing style of the rated writing patterns using NLP. The narrative style module 120 can also use the narrative style in combination with the previously analyzed factors (e.g., spelling mistakes, images, writing style, format, mixed different language) to increase the entropy of the attack detection system 100. In embodiments, the narrative style module 120 sends the narrative style and the rated writing pattern to the writing profile model module 125.

The writing profile model module 125 receives the narrative style and the rated writing pattern to build and train a writing profile model. In embodiments, the writing profile model is an artificial intelligence (AI) model which is trained using historical data of the narrative style and the rated writing pattern. In specific embodiments, the writing profile model comprise a generative AI model, such as a large language model (LLM). In other embodiments, the writing profile model comprises a machine learning (ML) model which is trained using historical data of the narrative style and the rated writing pattern.

The writing profile model module 125 also creates a writing profile based on the narrative style, the rated writing pattern, and the trained writing profile model and sends the writing profile to the writing profile database 130. The writing profile database 130 stores all of the writing profiles for training the writing profile model. The writing profile model module 125 also communicates with the writing profile database 130 for comparing the stored writing profiles with a currently incoming email. The writing profile model module 125 sends the stored writing profiles and the narrative style and the rated writing pattern of the currently incoming email to the correlation module 135.

The correlation module 135 receives the stored writing profiles and the narrative style and the rated writing patterns of the current incoming email and compares the stored writing profiles with the narrative style and the rated writing patterns of a current incoming email. In particular, the correlation module 135 determines a plurality of deltas by comparing the stored writing profiles with the narrative style and the rated writing patterns of the current incoming email. In embodiments, each of the deltas comprise a difference between the stored writings profiles and the narrative style and the rated writing patterns of the current incoming email. The correlation module 135 will then send the plurality of deltas to the flag detection module 140.

The flag detection module 140 receives the plurality of delta and determines whether each of the plurality of deltas are above a confidence parameter threshold. The flag detection module 140 flags the current incoming email as a potential scam and outputs the flagged email in response to a determination that a specified percentage of the plurality of deltas are above the confidence parameter threshold. In further embodiments, the flag detection module 140 outputs the flagged email to the user device.

In an example, the specified percentage may be over a predetermined percentage, e.g., over 50%, over 60%, or over 90%. Accordingly, in one example, the flag detection module 140 flags the current incoming email as a potential scam in response to a determination that over 50% of the plurality of deltas are above the confidence parameter threshold. In another example, the specified percentage is variable depending on an industry or a type of business organization. Further, the flag detection module 140 does not flag the current incoming email as a potential scam in response to a determination that the specified percentage of the plurality of deltas are below the confidence parameter threshold. Accordingly, in this example, the flag detection module 140 does not flag the current incoming email as a potential scam in response to a determination that only 35% of the plurality of deltas are above the confidence parameter threshold.

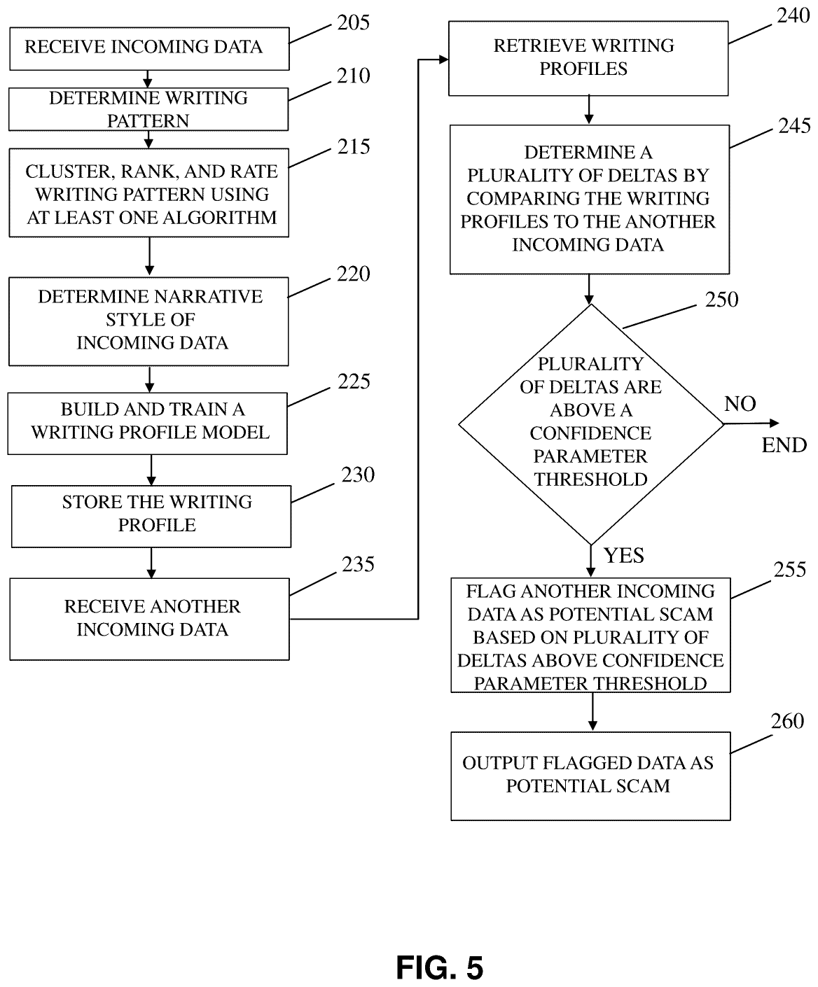

FIG. 5 shows a flowchart of an exemplary method in accordance with aspects of the present invention. Steps of the method may be carried out in the environment of FIG. 4 and are described with reference to elements depicted in FIG. 4. As noted herein, data may refer to any electronic communication such as an email, instant messaging, corporate messaging, etc.

At step 205, the system receives, at the writing pattern detection module 110, incoming data. At step 210, the system determines, at the writing pattern detection module 110, a writing pattern of the incoming data. In embodiments, and as described with respect to FIG. 4, the writing pattern detection module 110 scans the incoming data and determines the writing pattern of the incoming data using NLP techniques by detecting spelling mistakes, different languages or a mix of languages (including grammatical idiosyncrasies when combining different languages), images (e.g., type of bullets, position preferences of the images, etc.), a writing style (e.g., indentation, comma usage, spaces between sentences/paragraphs, grammar, etc.), and a format (e.g., bold, italics, colors, use of tildes, use of titles, etc.). In further embodiments, the writing pattern detection module 110 then sends the writing pattern of the incoming data to the ranking and rating module 115.

At step 215, the system clusters, ranks, and rates, at the ranking and rating module 115, the writing pattern of the incoming data. In embodiments, and as described with respect to FIG. 4, the rank and rating module 115 clusters using the BIRCH and affinity propagation clustering algorithms, ranks the clustered writing patterns based on a number of occurrences, and rates the ranked writing patterns. The ranking and rating module 115 sends the rated writing patterns to the narrative style module 120.

At step 220, the system determines, at the narrative style module 120, a narrative style based on the rated writing patterns. In embodiments, and as described with respect to FIG. 4, the narrative style module 120 determines the narrative style of the rated writing patterns using NLP. The narrative style module 120 sends the narrative style and the rated writing patterns to the writing profile model module 125.

At step 225, the system builds and trains, at the writing profile model module 125, a writing profile model based on the narrative style and the rated writing patterns. At step 230, the system stores, at the writing profile model module 125, a writing profile at the writing profile database 130. In embodiments, and as described with respect to FIG. 4, the writing profile model module 125 creates a writing profile based on the narrative style, the rated writing pattern and the trained writing profile model and sends the writing profile to the writing profile database 130.

At step 235, the system receives, at the correlation module 135, another incoming data. At step 240, the system retrieves, at the correlation module 135, the stored writing profiles from the writing profile model module 125. At step 245, the system determines, at the correlation module 135, a plurality of deltas by comparing the retrieved writing profiles in the trained writing profile model module to the incoming data. In embodiments, and as described with respect to FIG. 4, the correlation module 135 sends the plurality of deltas to the flag detection module 140.

At step 250, the system determines, at the flag detection module 140, whether each of the plurality of deltas are above a confidence parameter threshold. At step 255, the system flags, at the flag detection module 140, the incoming data as a potential scam in response to a determination that a specified percentage of the plurality of deltas are above the confidence parameter threshold. In embodiments, and as described with respect to FIG. 4, the flag detection module 140 flags the incoming data as a potential scam in response to a determination that over, for example, 50% of the plurality of deltas are above the confidence parameter threshold. In FIG. 5, the flowchart ends in response to the determination that the specified percentage of the plurality of deltas is equal to or below the confidence parameter threshold.

At step 260, the system outputs, at the flag detection module 140, the incoming data as the potential scam in response to flagging the incoming datal as the potential scam. In embodiments, and as described with respect to FIG. 4, the flag detection module 140 outputs the flagged incoming data to the user device.

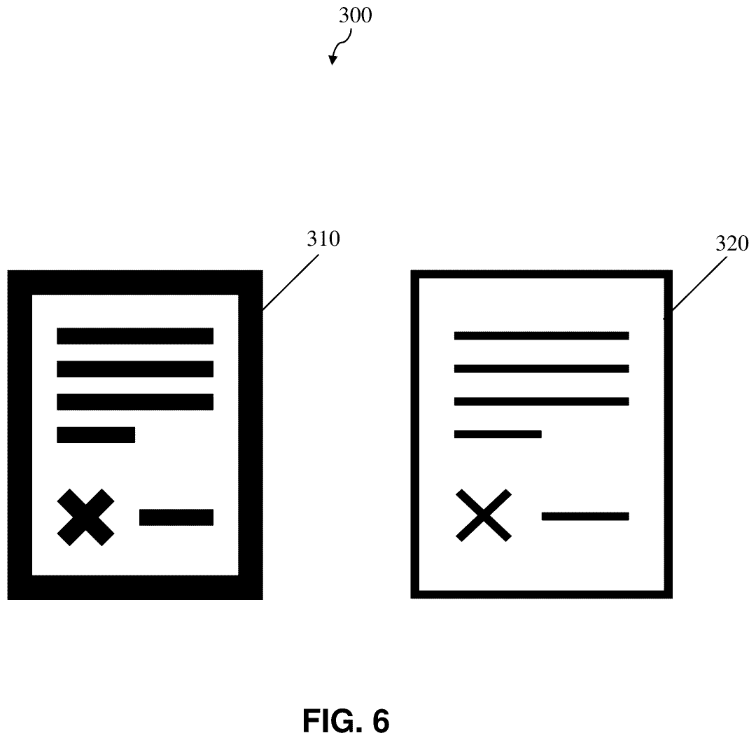

FIG. 6 shows highly representative writing pattern examples of a writing pattern detection module in accordance with aspects of the present invention. In FIG. 6, the writing pattern examples 300 include a first writing pattern 310 of a first sender which includes a use of rich text, an analytical narrative style, and perfect grammar. Further, the writing pattern examples 300 include a second writing pattern 320 of a second sender which includes no use of rich text, a definition narrative style, and inaccurate grammar. In embodiments of FIG. 6, the first sender is a different sender than the second sender.

FIG. 7 shows an example of the ranking and rating module in accordance with aspects of the present invention. In FIG. 7, the ranking and rating module 115 ranks the clustered writing patterns based on a number of occurrences. In particular, the ranking and rating module 115 uses the BIRCH algorithm for a ranking example 330 which includes bold occurrences, a number of underline occurrences, a number of custom font occurrences for a format, a number of misspelled words (e.g., achieve, beginning, etc.), and a number of rich text occurrences. For example, a first clustered writing pattern with five bold occurrences, ten underlined occurrences, and fifteen misspelled words may be ranked lower than a second clustered writing pattern with four bold occurrences, nine underlined occurrences, and ten misspelled words.

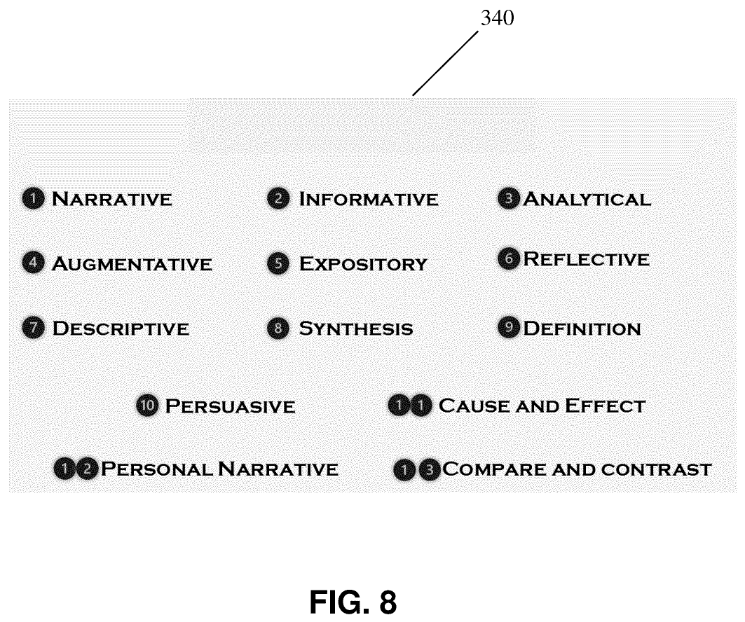

FIG. 8 shows narrative style examples of narrative style module in accordance with aspects of the present invention. In FIG. 8, the narrative style module 120 detects a plurality of narrative style examples 340. The narrative style examples 340 include a narrative style, an informative style, an analytical style, an augmentative style, an expository style, a reflective style, a descriptive style, a synthesis style, a definition style, a persuasive style, a cause and effect style, a personal narrative style, a compare and contrast style. However, embodiments of the present invention are not limited to these narrative styles and may include other narrative styles.

In embodiments, the analytical style comprises a topic with strong detail and critical thinking. The augmentative style comprises an argument. The expository style comprises critical thinking to explore a topic. The reflective style comprises an idea, concept, or other observation from a point of view. The descriptive style comprises narration set to a scene. The synthesis style comprises gathering opinions, evidences, and proposals from various sources which may be present in one document. In further embodiments, (i) the definition style defines a term or idea, (ii) the persuasive style tries to convince readers to agree with their viewpoint, (iii) the cause and effect style uses a structure to show the relationship between an event and its consequences, (iv) the personal narrative style is a form of narrative writing in which a writer explains how an experience affected or shaped them, and (v) compare and contrast style are analytical essays that examine how two subjects are similar and different.

FIG. 9 shows an example of flag detection in accordance with aspects of the present invention. In the example 350 of FIG. 9, the flag detection module 140 flags the current incoming email 360 as a potential scam in response to a determination that a specified percentage of a plurality of deltas are above a confidence parameter threshold and outputs the current incoming email 360 as a potential scam. In the example 350, the current incoming email 360 is flagged by marking the current incoming email 350 with an overlayed text “flagged as potential scam”; although other indicia is also contemplated herein.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
determining, by the computing device, a set of writing patterns of at least one data communication;
determining, by the computing device, a narrative style on the set of writing patterns of the at least one data communication;
providing, by the computing device, a writing profile model by training on the narrative style and the set of writing patterns;
comparing, by the computing device, a new data communication to the trained writing profile model; and
flagging, by the computing device, the new data communication based on the comparison being over a threshold level.

2. The method of claim 1, further comprising creating a writing profile based on the narrative style, the set of writing patterns, and the trained writing profile model of the at least one data communication.

3. The method of claim 2, further comprising storing the writing profile in a writing profile database.

4. The method of claim 1, further comprising clustering the set of writing patterns using at least one of a balanced iterative reducing and clustering using hierarchies (BIRCH) algorithm and an affinity propagation clustering algorithm.

5. The method of claim 4, further comprising ranking and rating the clustered writing patterns.

6. The method of claim 5, wherein the training is provided on the ranked and rated clustered writing patterns.

7. The method of claim 6, wherein the new data communication comprises an email message.

8. The method of claim 1, wherein the writing profile model comprises an artificial intelligence (AI) model which is further trained using historical data of the narrative style and historical data of the set of writing patterns.

9. The method of claim 1, wherein the writing profile model comprises a machine learning (ML) model which is further trained using historical data of the narrative style and historical data of the set of writing patterns.

10. The method of claim 1, wherein the at least one data communication comprises an email message.

11. The method of claim 1, wherein flagging the new data communication based on the comparison over the threshold level comprises:
determining a plurality of deltas based on the comparison of a plurality of writing profiles in the trained writing profile model to the new data communication; and
determining whether a set of the plurality of deltas is over the threshold level.

12. The method of claim 11, wherein flagging the new data communication based on the comparison over the threshold level further comprises:
determining the set comprises at least a specified percentage of the plurality of deltas.

13. The method of claim 12, wherein flagging the new data communication based on the comparison over the threshold level further comprises:
flagging the new data communication as a potential scam.

14. A computer program product comprising one or more computer readable storage media having program instructions collectively stored on the one or more computer readable storage media, the program instructions executable to:
determine a set of writing patterns of at least one data communication;
determine a narrative style on the set of writing patterns of the at least one data communication;
provide a writing profile model by training on the narrative style and the set of writing patterns;
compare a new data communication to the trained writing profile model; and
flag the new data communication based on the comparison being over a threshold level.

15. The computer program product of claim 14, further comprising clustering the set of writing patterns using a balanced iterative reducing and clustering using hierarchies (BIRCH) algorithm.

16. The computer program product of claim 14, further comprising clustering the set of writing patterns using an affinity propagation clustering algorithm.

17. The computer program product of claim 14, wherein the writing profile model comprises an artificial intelligence (AI) model which is further trained using historical data of the narrative style and historical data of the set of writing patterns.

18. The computer program product of claim 14, wherein the writing profile model comprises a machine learning (ML) model which is further trained using historical data of the narrative style and historical data of the set of rated writing patterns.

19. The computer program product of claim 14, wherein flagging the new data communication based on the comparison over the threshold level comprises:
determining a plurality of deltas based on the comparison of a plurality of writing profiles in the trained writing profile model to the new data communication;
determining whether a set of the plurality of deltas is over the threshold level;
determining the set comprises at least a specified percentage of the plurality of deltas; and
flagging the new data communication as a potential scam.

20. A system comprising:
a processor, a computer readable memory, one or more computer readable storage media, and program instructions collectively stored on the one or more computer readable storage media, the program instructions executable to:
receive at least one incoming email from a user device;
determine at least one writing pattern based on the at least one incoming email;
cluster the at least one writing pattern using at least one algorithm;
rank the clustered at least one writing pattern;
rate the ranked at least one writing pattern;
determine a narrative style based on the rated at least one writing pattern;
provide a writing profile model by training on the narrative style and the rated at least one writing pattern;
compare a new email to the trained writing profile model; and
flag the new email based on the comparison being over a threshold level.
